(19) United States
(12) Patent Application Publication
(10) Pub. No.: US 2025/0166920 A1
(43) Pub. Date: May 22, 2025

(54) MULTILAYER CERAMIC CAPACITOR

(71) Applicant: SAMSUNG ELECTRO-MECHANICS CO., LTD., Suwon-si (KR)

(72) Inventors: Sungsoo Kim, Suwon-si (KR); Jaeyoung Na, Suwon-si (KR); Chungyeol Lee, Suwon-si (KR); Junil Kang, Suwon-si (KR)

(73) Assignee: SAMSUNG ELECTRO-MECHANICS CO., LTD., Suwon-si (KR)

(21) Appl. No.: 18/422,752

(22) Filed: Jan. 25, 2024

(30) Foreign Application Priority Data
Nov. 16, 2023 (KR) 10-2023-0158891

(51) Int. Cl. H01G 4/30; H01G 4/008; H01G 4/012; H01G 4/12; H01G 4/232

(52) U.S. Cl. CPC H01G 4/30; H01G 4/008; H01G 4/012; H01G 4/12; H01G 4/232

(57) ABSTRACT

An embodiment of the present disclosure provides a multilayer ceramic capacitor, including: a ceramic body that includes a plurality of dielectric layers and a plurality of internal electrodes stacked in a first direction, and an external electrode disposed outside the ceramic body, in which the internal electrode includes a protrusion that protrudes from a surface of the ceramic body and contacts an interdiffusion portion, and the interdiffusion portion includes an alloy or an intermetallic compound (IMC) of a material of the internal electrode and a material of the external electrode.

### CROSS-REFERENCE TO RELATED APPLICATION

The present application claims the benefit of priority to Korean Patent Application No. 10-2023-0158891 filed on Nov. 16, 2023 in the Korean Intellectual Property Office, the entire contents of which are incorporated herein by reference.

### BACKGROUND

### Field

The present disclosure relates to a multilayer ceramic capacitor.

### Description of the Related Art

Electronic components using ceramic materials include capacitors, inductors, piezoelectric elements, varistors, thermistors, etc. Among these ceramic electronic components, multilayer ceramic capacitors (MLCCs) can be used in various electronic devices due to their small size, high capacity, and ease of mounting.

For example, the multilayer ceramic capacitors may be used in chip-type condensers that are mounted on substrates of various electronic products such as imaging devices such as liquid crystal displays (LCDs), plasma display panels (PDPs), and organic light-emitting diodes (OLEDs), computers, personal portable devices, and smartphones and that serve to charge or discharge electricity.

The multilayer ceramic capacitor may include an internal electrode disposed inside a ceramic body and an external electrode disposed outside the ceramic body and connected to the internal electrode. When the material of the external electrode and the material of the internal electrode are different from each other, a radiating crack may occur as the two materials diffuse into each other.

### SUMMARY

An aspect of an embodiment is to provide a multilayer ceramic capacitor that may prevent occurrence of a radiating crack.

An embodiment provides a multilayer ceramic capacitor, including: a ceramic body that includes a plurality of dielectric layers and a plurality of internal electrodes stacked in a first direction, and an external electrode disposed outside the ceramic body, in which the internal electrode includes a protrusion that protrudes from a first surface of the ceramic body and contacts an interdiffusion portion, and the interdiffusion portion includes an alloy or an intermetallic compound (IMC) of a material of the internal electrode and a material of the external electrode.

The interdiffusion portion may surround the protrusion.

The interdiffusion portion may be disposed on the first surface of the ceramic body.

The material of the internal electrode may include nickel (Ni), copper (Cu), palladium (Pd), silver (Ag), iron (Fe), or an alloy thereof.

The material of the external electrode may include nickel (Ni), copper (Cu), palladium (Pd), gold (Au), silver (Ag), cobalt (Co), chromium (Cr), iron (Fe), tin (Sn), platinum (Pt), indium (In), iridium (Ir), rhodium (Rh), tin (Sn), zinc (Zn), or an alloy thereof.

A length of the interdiffusion portion may be greater than a length of the protrusion of the internal electrode.

A length of the interdiffusion portion may be 0.5 μm or more and 2 μm or less.

The multilayer ceramic capacitor may further include a plating layer that covers the external electrode.

The plating layer may include a first layer that covers the external electrode, a second layer that covers the first layer, and a third layer that covers the second layer.

The first layer may include nickel (Ni), the second layer may include copper (Cu), and the third layer may include tin (Sn).

Each of the internal electrodes may include a protrusion that protrudes from the first surface of the ceramic body, and a plurality of interdiffusion portions that includes an alloy or an intermetallic compound (IMC) of a material of the internal electrodes and a material of the external electrode surround the protrusions of the internal electrodes, respectively.

The plurality of interdiffusion portions may be spaced apart from one another.

The external electrode may include an end portion that covers a portion of the first surface of the ceramic body, a band portion that extends from the end portion to cover at least a portion of four surfaces of the ceramic body connected to the first surface, and an edge portion that connects the end portion and the band portion.

According to the multilayer ceramic capacitor according to the embodiment, an alloy or intermetallic compound may be formed between a protrusion of an internal electrode that protrudes outwardly from the ceramic body and an external electrode to prevent the occurrence of radiating cracks.

### BRIEF DESCRIPTION OF THE DRAWINGS

FIG. 1 schematically illustrates a perspective view of a multilayer ceramic capacitor according to an embodiment.

FIG. 2 illustrates a cross-sectional view taken along line II-II′ of FIG. 1.

### DETAILED DESCRIPTION OF THE EMBODIMENTS

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

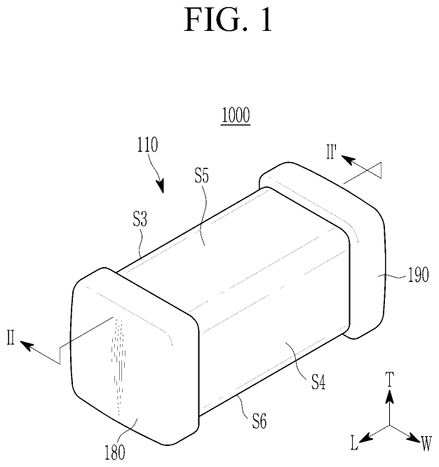

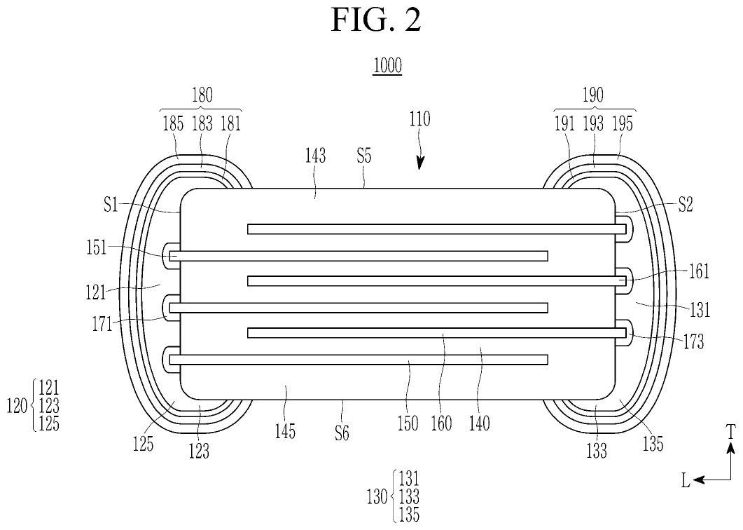

FIG. 1 schematically illustrates a perspective view of a multilayer ceramic capacitor according to an embodiment, and FIG. 2 illustrates a cross-sectional view taken along line II-II′ of FIG. 1.

Referring to FIG. 1 and FIG. 2, a multilayer ceramic capacitor 1000 according to the present embodiment includes a ceramic body 110, a first external electrode 120, a second external electrode 130, a plurality of first internal electrodes 150, and a plurality of second internal electrodes 160.

First, defining directions to clearly describe the present embodiment, an L-axis, a W-axis, and a T-axis shown in the drawings indicate axes representing a length direction, a width direction, and a thickness direction of the multilayer ceramic capacitor 1000, respectively.

The thickness direction (T-axis direction) may be a direction perpendicular to a wide surface (main surface) of sheet-shaped components. For example, the thickness direction (T-axis direction) may be used as the same concept as a direction in which a dielectric layer 140 is stacked.

The length direction (L-axis direction) is a direction parallel to the wide surface (main surface) of the sheet-shaped components, and may be a direction that intersects (or is perpendicular to) the thickness direction (T-axis direction). For example, the length direction (L-axis direction) may be a direction in which the first external electrode 120 and the second external electrode 130 face each other.

The width direction (W-axis direction) is a direction parallel to the wide surface (main surface) of the sheet-shaped components, and may be a direction that simultaneously intersects (or is perpendicular to) the thickness direction (T-axis direction) and the length direction (L-axis direction).

The ceramic body 110 may have a substantially hexahedral shape, but the present embodiment is not limited thereto. Due to shrinkage during sintering, the ceramic body 110 may have a substantially hexahedral shape, although not a fully hexahedral shape. For example, the ceramic body 110 may have a substantially rectangular hexahedral shape, but corner or vertex portions may have a round shape.

In the present embodiment, for convenience of description, surfaces facing each other in the length direction (L-axis direction) are defined as a first surface S1 and a second surface S2, surfaces facing each other in the width direction (W-axis direction) and connecting the first surface S1 and the second surface S2 are defined as a third surface S3 and a fourth surface S4, and surfaces facing each other in the thickness direction (T-axis direction) and connecting the first surface S1 and the second surface S2 are defined as a fifth surface S5 and a sixth surface S6.

Accordingly, the first direction in which the first surface S1 and the second surface S2 face each other may be the length direction (L-axis direction), and the second direction and the third direction that are perpendicular to the first direction and perpendicular to each other may be the thickness direction (T-axis direction) and the width direction (W-axis direction), or the width direction (W-axis direction) and the thickness direction (T-axis direction), respectively.

A length of the ceramic body 110 may refer to, based on an optical microscope or scanning electron microscope (SEM) photograph of a cross-section taken along the length direction (L-axis direction)-the thickness direction (T-axis direction) at a center of the ceramic body 110 in the width direction (W-axis direction), a maximum value of lengths of a plurality of line segments that connect two outermost boundary lines facing each other in the length direction (L-axis direction) of the ceramic body 110 shown in the above cross-sectional photograph and are parallel to the length direction (L-axis direction). Meanwhile, the length of the ceramic body 110 may refer to a minimum value of lengths of a plurality of line segments that connect two outermost boundary lines facing each other in the length direction (L-axis direction) of the ceramic body 110 shown in the above cross-sectional photograph and are parallel to the length direction (L-axis direction). On the other hand, the length of the ceramic body 110 may refer to an arithmetic mean value of lengths of at least two of a plurality of line segments that connect two outermost boundary lines facing each other in the length direction (L-axis direction) of the ceramic body 110 shown in the above cross-sectional photograph and are parallel to the length direction (L-axis direction). The length of the ceramic body 110 may be measured by a standard method that will be apparent to and understood by one of ordinary skill in the art.

A thickness of the ceramic body 110 may refer to, based on an optical microscope or scanning electron microscope (microscope SEM) photograph of a cross-section taken along, the length direction (L-axis direction)—the thickness direction (T-axis direction) at a center of the ceramic body 110 in the width direction (W-axis direction), a maximum value of lengths of a plurality of line segments that connect two outermost boundary lines facing each other in the thickness direction (T-axis direction) of the ceramic body 110 shown in the above cross-sectional photograph and are parallel to the thickness direction (T-axis direction). Meanwhile, the thickness of the ceramic body 110 may refer to a minimum value of lengths of a plurality of line segments that connect two outermost boundary lines facing each other in the thickness direction (T-axis direction) of the ceramic body 110 shown in the above cross-sectional photograph and are parallel to the thickness direction (T-axis direction). On the other hand, the thickness of the ceramic body 110 may refer to an arithmetic mean value of lengths of at least two of a plurality of line segments that connect two outermost boundary lines facing each other in the thickness direction (T-axis direction) of the ceramic body 110 shown in the above cross-sectional photograph and are parallel to the thickness direction (T-axis direction). The thickness of the ceramic body 110 may be measured by a standard method that will be apparent to and understood by one of ordinary skill in the art.

A width of the ceramic body 110 may refer to, based on an optical microscope or scanning electron microscope (microscope SEM) photograph of a cross-section taken along the length direction (L-axis direction)-the width direction (W-axis direction) at a center of the ceramic body 110 in the thickness direction (T-axis direction), a maximum value of lengths of a plurality of line segments that connect two outermost boundary lines facing each other in the width direction (W-axis direction) of the ceramic body 110 shown in the above cross-sectional photograph and are parallel to the width direction (W-axis direction). Meanwhile, the width of the ceramic body 110 may refer to a minimum value of lengths of a plurality of line segments that connect two outermost boundary lines facing each other in the width direction (W-axis direction) of the ceramic body 110 shown in the above cross-sectional photograph and are parallel to the width direction (W-axis direction). On the other hand, the width of the ceramic body 110 may refer to an arithmetic mean value of lengths of at least two of a plurality of line segments that connect two outermost boundary lines facing each other in the width direction (W-axis direction) of the ceramic body 110 shown in the above cross-sectional photograph and are parallel to the width direction (W-axis direction). The width of the ceramic body 110 may be measured by a standard method that will be apparent to and understood by one of ordinary skill in the art.

The ceramic body 110 may include a plurality of dielectric layers 140 stacked in the thickness direction (T-axis direction). Boundaries between the dielectric layers 140 may be unclear. For example, the boundary between the dielectric layers 140 is difficult to confirm without using a scanning electron microscope (SEM), and the plurality of dielectric layers 140 may appear to be an integral structure.

The first internal electrode 150 and the second internal electrode 160 may be alternately stacked with the dielectric layer 140 interposed therebetween. This stacked structure may be repeated within the ceramic body 110, and the internal electrode closest to the fifth surface S5 of the ceramic body 110 may be the first internal electrode 150 or the second internal electrode 160. Similarly, the internal electrode closest to the sixth surface S6 of the ceramic body 110 may be the first internal electrode 150 or the second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be disposed to be offset from each other in the length direction (L-axis direction) with the dielectric layer 140 interposed therebetween. An end of the first internal electrode 150 may be exposed from the first surface S1 of the ceramic body 110, and an end of the second internal electrode 160 may be exposed from the second surface S2 of the ceramic body 110. That is, the first internal electrode 150 may include a first protrusion 151 protruding from the first surface S1 of the ceramic body 110, and the second internal electrode 160 may include a second protrusion 161 protruding from the second surface S2 of the ceramic body 110. The first protrusion 151 of the first internal electrode 150 may be connected to the first external electrode 120, and the second protrusion 161 of the second internal electrode 160 may be connected to the second external electrode 130. This will be described later.

For example, each of the first internal electrode 150 and the second internal electrode 160 may include nickel (Ni), copper (Cu), palladium (Pd), silver (Ag), iron (Fe), or an alloy thereof.

The first internal electrode 150 and the second internal electrode 160 may be formed by printing a conductive paste that includes a conductive metal on the surface of the dielectric layer 140. For example, an internal electrode may be formed by printing a conductive paste that contains nickel (Ni) or a nickel (Ni) alloy on the surface of the dielectric layer using screen printing or gravure printing. However, the present embodiment is not limited thereto.

For example, the average thickness of the first internal electrode 150 and the second internal electrode 160 may be approximately 0.1 μm or more and 2 μm or less, respectively.

Here, the thickness of the internal electrode 150 or 160 may refer to the average thickness of one internal electrode disposed between two dielectric layers. The average thickness of the internal electrode may be an arithmetic mean of values of the thickness of one internal electrode, shown in the above-described cross-sectional photograph, measured at 30 equally spaced points in the length direction (L-axis direction), based on the scanning electron microscope (SEM) photograph of the 10,000 magnification for a cross section taken along the length direction (L-axis direction)-thickness direction (T-axis direction) at the center of the ceramic body 110 in the width direction (W-axis direction). The above-mentioned 30 points may be designated in an active area to be described later. In this way, by respectively measuring the average thickness of 10 internal electrodes and then deriving the arithmetic mean value of the measured values, the average thickness of the internal electrodes may be further generalized. The measurement of an average thickness is not limited to these examples, and one of ordinary skill may select the number of measurement points, the interval between the measurement points, the number of internal electrodes, and so forth, if needed.

According to the above configuration, when a voltage is applied to the first external electrode 120 and the second external electrode 130, charges accumulate between the first internal electrode 150 and the second internal electrode 160 facing each other. That is, capacitance may be obtained between the first internal electrode 150 electrically connected to the first external electrode 120 and the second internal electrode 160 electrically connected to the second external electrode 130. The capacitance of the multilayer ceramic capacitor 1000 is proportional to the overlapping area of the first internal electrode 150 and the second internal electrode 160, which overlap each other along the thickness direction (T-axis direction).

In other words, the multilayer ceramic capacitor 1000 may include an active area and a margin area. The active area may refer to an area where the first internal electrode 150 and the second internal electrode 160 overlap along the thickness direction (T-axis direction), and the margin area may refer to an area between the active area and the first surface S1 of the ceramic body 110 and an area between the active area and the second surface S2 of the ceramic body 110. Meanwhile, an area between the active area and the third surface S3 of the ceramic body 110 and an area between the active area and the fourth surface S4 of the ceramic body 110 may also be referred to as the margin area.

A first cover layer 143 and a second cover layer 145 may be disposed outside the active area in the thickness direction (T-axis direction).

The first cover layer 143 is disposed between the fifth surface S5 of the ceramic body 110 and the internal electrode closest thereto. The second cover layer 145 is disposed between the sixth surface S6 of the ceramic body 110 and the internal electrode closest thereto.

That is, the first cover layer 143 may be disposed on an upper portion of the uppermost internal electrode in the ceramic body 110, and the second cover layer 145 may be disposed on a lower portion of the lowermost internal electrode. The first cover layer 143 and the second cover layer 145 may have the same composition as that of the dielectric layer 140. The first cover layer 143 and the second cover layer 145 may be formed by stacking one or more dielectric layers on the outer surface of the uppermost internal electrode and the outer surface of the lowermost internal electrode, respectively. Meanwhile, the first cover layer 143 and the second cover layer 145 may have a different composition from the dielectric layer 140.

The first cover layer 143 and the second cover layer 145 may serve to prevent damage to the first internal electrode 150 and the second internal electrode 160 due to physical or chemical stress.

The dielectric layer 140 may include a ceramic material having a high permittivity. For example, the ceramic material may include a dielectric ceramic including elements such as BaTiO₃, CaTiO₃, SrTiO₃, or CaZrO₃. In addition, auxiliary components such as a manganese (Mn) compound, an iron (Fe) compound, a chromium (Cr) compound, a cobalt (Co) compound, and a nickel (Ni) compound may be further included in these components. For example, the dielectric layer may include (Ba₁₋ₓCaₓ)TiO₃, Ba(Ti_{1-y}Ca_{y})O₃, (Ba₁₋ₓCaₓ) (Ti_{1-y}Zr_{y})O₃, or Ba(Ti_{1-y}Zr_{y})O₃, in which calcium (Ca), zirconium (Zr), and the like are partially dissolved into BaTiO₃, but the present disclosure is not limited thereto.

In addition, the dielectric layer 140 may further include one or more of ceramic additives, organic solvents, plasticizers, binders, and dispersants. The ceramic additive may be, for example, a transition metal oxide or carbide, a rare earth element, magnesium (Mg), or aluminum (Al).

For example, the average thickness of the dielectric layer 140 may be 0.1 μm to 10 μm, but the present embodiment is not limited thereto.

The first external electrode 120 and the second external electrode 130 are disposed outside the ceramic body 110.

For example, the first external electrode 120 and the second external electrode 130 may include nickel (Ni), copper (Cu), palladium (Pd), gold (Au), silver (Ag), cobalt (Co), chromium (Cr), iron (Fe), tin (Sn), platinum (Pt), indium (In), iridium (Ir), rhodium (Rh), zinc (Zn), or an alloy thereof.

The first external electrode 120 is disposed on the first surface S1 of the ceramic body 110 and may extend to the third surface S3, the fourth surface S4, the fifth surface S5, and the sixth surface S6. The second external electrode 130 is disposed on the second surface S2 of the ceramic body 110 and may extend to the third surface S3, the fourth surface S4, the fifth surface S5, and the sixth surface S6. In other embodiments, the first external electrode 120 and the second external electrode 130 may extend to a portion of at least one of the fifth surface S5 and the sixth surface S6.

The first external electrode 120 includes a first end portion 121, a first band portion 123, and a first edge portion 125.

The first end portion 121 covers the first surface S1 of the ceramic body 110 and is electrically connected to the first protrusion 151 of the plurality of first internal electrodes 150.

A first interdiffusion portion 171 may be disposed between the first end portion 121 and the first protrusion 151. The first interdiffusion portion 171 may include an alloy or an intermetallic compound (IMC) formed by interdiffusion of the material of the first external electrode 120 and the material of the first internal electrode 150.

The presence of the first interdiffusion portion 171 and its composition may be determined by performing energy dispersive spectroscopy (EDS). For example, a multilayer ceramic capacitor is manufactured and then mounted in an epoxy mold, the length (L-axis direction)-thickness direction (T-axis direction) surface is polished to a depth of about ½ along the width direction (W-axis direction), and finished with a diamond paste to prepare a cross-sectional sample. In the prepared cross-sectional samples, a place where the first or second external electrode is seen about 70 μm from the interface of the first or second external electrode with the ceramic body toward a plating layer, is measured with a field emission (FE)-transmission electron microscope (TEM) and energy dispersive spectral element analysis (EDS) is performed, thereby determining the presence of the first interdiffusion portion 171 and its composition.

For example, if the material of the first internal electrode 150 includes nickel (Ni), the material of the first external electrode 120 may include silver (Ag), gold (Au), cobalt (Co), chromium (Cr), copper (Cu), iron (Fe), tin (Sn), platinum

(Pt), palladium (Pd), or an alloy thereof.

As another example, if the material of the first internal electrode 150 includes copper (Cu), the material of the first external electrode 120 may include silver (Ag), gold (Au), cobalt (Co), chromium (Cr), iron (Fe), indium (In), iridium (Ir), nickel (Ni), Palladium (Pd), platinum (Pt), rhodium (Rh), tin (Sn), zinc (Zn), or an alloy thereof.

As yet another example, if the material of the first internal electrode 150 includes palladium (Pd), the material of the first external electrode 120 may include copper (Cu), iron (Fe), nickel (Ni), rhodium (Rh), tin (Sn), or an alloy thereof.

As yet another example, if the material of the first internal electrode 150 includes silver (Ag), the material of the first external electrode 120 may include gold (Au), cobalt (Co), chromium (Cr), iron (Fe), indium (In), nickel (Ni), palladium (Pd), tin (Sn), zinc (Zn), or an alloy thereof.

The first interdiffusion portion 171 may be in contact with the first protrusion 151 of the first internal electrode 150. The first interdiffusion portion 171 may surround the first protrusion 151 of the first internal electrode 150. The first interdiffusion portion 171 may be disposed on the first surface S1 of the ceramic body 110. The first interdiffusion portion 171 may be in contact with the first surface S1 of the ceramic body 110. For example, the first interdiffusion portion 171 may be in contact with and surround the first protrusion 151 of the first internal electrode 150, and contact the first surface S1 of the ceramic body 110.

The cross-sectional shape of the first interdiffusion portion 171 may be a circle, triangle, or rectangle, but the present embodiment is not limited thereto. The cross-sectional shape of the first interdiffusion portion 171 may be confirmed based on an optical microscope or scanning electron microscope (SEM) photograph of a cross section taken along the length (L-axis direction)-thickness direction (T-axis direction) at a center of the ceramic body 110 in the width direction (W-axis direction).

Meanwhile, a length of the first interdiffusion portion 171 is greater than a length of the first protrusion 151. The length of the first interdiffusion portion 171 may be 0.5 μm or more and 2 μm or less, and the length of the first protrusion 151 may be smaller than the length of the first interdiffusion portion 171. If the length of the first interdiffusion portion 171 is less than 0.5 μm, the first protrusion 151 is shorter than that, so there is a possibility that the electrical connection between the first internal electrode 150 and the first external electrode 120 is poor and a short circuit may occur. Meanwhile, if the length of the first interdiffusion portion 171 exceeds 2 μm, the continuity of the first external electrode 120 may be reduced.

The length of the first interdiffusion portion 171 and the length of the first protrusion 151 may be confirmed based on an optical microscope or scanning electron microscope (SEM) photograph of a cross section taken along the length direction (L-axis direction)—thickness direction (T-axis direction) at a center of the ceramic body 110 in the width direction (W-axis direction). The length of the first interdiffusion portion 171 may be an arithmetic mean value of the distance between the outer surface of three uppermost first interdiffusion portions 171 in the length direction (L-axis direction) of the ceramic body 110 and the first surface S1 of the ceramic body 110 shown in the above-described cross-sectional photograph, the distance between the outer surface of three lowermost first interdiffusion portions 171 in the length direction (L-axis direction) and the first surface S1 of the ceramic body 110, and the distance between the outer surface of three central first interdiffusion portions 171 in the length direction (L-axis direction) and the first surface S1 of the ceramic body 110. In addition, the length of the first protrusion 151 may be an arithmetic mean value of the length of three uppermost first protrusions 151 in the length direction (L-axis direction) of the ceramic body 110 shown in the above-described cross-sectional photograph, the length of three lowermost first protrusions 151 in the length direction (L-axis direction), and the length of three central first protrusions 151 in the length direction (L-axis direction). The length of the first interdiffusion portion 171 and the length of the first protrusion 151 may be measured by a standard method that will be apparent to and understood by one of ordinary skill in the art.

In other embodiments, the first end portion 121 may cover a portion of the first surface S1 of the ceramic body 110.

The first band portion 123 extends from the first end portion 121 to cover at least a portion of the third surface S3, the fourth surface S4, the fifth surface S5, and the sixth surface S6 of the ceramic body 110. The first band portion 123 may allow the first external electrode 120 to be more strongly adhered to the ceramic body 110.

The first edge portion 125 may be a portion that connects the first end portion 121 and the first band portion 123.

The second external electrode 130 includes a second end portion 131, a second band portion 133, and a second edge portion 135.

The second end portion 131 covers the second surface S2 of the ceramic body 110 and is electrically connected to the second protrusion 161 of the plurality of second internal electrodes 160.

A second interdiffusion portion 173 may be disposed between the second end portion 131 and the second protrusion 161. The second interdiffusion portion 173 may include an alloy or an intermetallic compound (IMC) formed by interdiffusion of the material of the second external electrode 130 and the material of the second internal electrode 160.

The second interdiffusion portion 173 may be in contact with the second protrusion 161 of the second internal electrode 160. The second interdiffusion portion 173 may surround the second protrusion 161 of the second internal electrode 160. The second interdiffusion portion 173 may be disposed on the second surface S2 of the ceramic body 110. The second interdiffusion portion 173 may be in contact with the second surface S2 of the ceramic body 110. For example, the second interdiffusion portion 173 may be in contact with and surround the second protrusion 161 of the second internal electrode 160, and contact the second surface S2 of the ceramic body 110.

The cross-sectional shape of the second interdiffusion portion 173 may be a circle, triangle, or rectangle, but the present embodiment is not limited thereto. The cross-sectional shape of the second interdiffusion portion 173 may be confirmed based on an optical microscope or scanning electron microscope (SEM) photograph of a cross section taken along the length (L-axis direction)-thickness direction (T-axis direction) at a center of the ceramic body 110 in the width direction (W-axis direction).

Meanwhile, a length of the second interdiffusion portion 173 is greater than a length of the second protrusion 161. The length of the second interdiffusion portion 173 may be 0.5 μm or more and 2 μm or less, and the length of the second protrusion 161 may be smaller than the length of the second interdiffusion portion 173.

If the length of the second interdiffusion portion 173 is less than 0.5 μm, the length of the second protrusion 161 is shorter than that, so there is a possibility that the electrical connection between the second internal electrode 160 and the second external electrode 130 is poor and a short circuit may occur. Meanwhile, if the length of the second interdiffusion portion 173 exceeds 2 μm, the continuity of the second external electrode 130 may be reduced.

Except for the location of the second interdiffusion portion 173, the remaining components thereof, such as structure and composition, are the same as or correspond to the components of the first interdiffusion portion 171, so redundant descriptions thereof will be omitted.

In other embodiments, the second end portion 131 may cover a portion of the second surface S2 of the ceramic body 110.

The second band portion 133 extends from the second end portion 131 to cover at least a portion of the third surface S3, the fourth surface S4, the fifth surface S5, and the sixth surface S6 of the ceramic body 110. The second band portion 133 may allow the second external electrode 130 to be more strongly adhered to the ceramic body 110.

The second edge portion 135 may be a portion that connects the second end portion 131 and the second band portion 133.

Based on an optical microscope or scanning electron microscope (SEM) photograph of a cross section taken in the length direction (L-axis direction)-thickness direction (T axis direction) at the center of the multilayer ceramic capacitor 1000 in the width direction (W-axis direction), in the multilayer ceramic capacitor 1000 shown in the above-described cross-sectional photograph, the first end portion 121 and the second end portion 131 may have a shape substantially parallel to the thickness direction (T-axis direction), the first band portion 123 and the second band portion 133 may have a shape substantially parallel to the length direction (L-axis direction), and the first edge portion 125 and the second edge portion 135 may have a curved line shape. The above-described curved line shape may be a curved line shape having a tangent whose slope changes from a direction parallel to the thickness direction (T-axis direction) to a direction parallel to the length direction (L-axis direction) (or in opposite directions).

Meanwhile, the first external electrode 120 may be covered by a first plating layer 180, and the second external electrode 130 may be covered by a second plating layer 190.

Both the first plating layer 180 and the second plating layer 190 may comprise a plurality of layers. For example, the first plating layer 180 may include a first layer 181 that covers the first external electrode 120, a second layer 183 that covers the first layer 181, and a third layer 185 that covers the second layer 183. The first layer may include nickel (Ni), the second layer may include copper (Cu), and the third layer may include tin (Sn), but the present embodiment is not limited thereto.

In addition, the second plating layer 190 may include a first layer 191 that covers the second external electrode 130, a second layer 193 that covers the first layer 191, and a third layer 195 that covers the second layer 193. The first layer 191 may include nickel (Ni), the second layer 193 may include copper (Cu), and the third layer 195 may include tin (Sn), but the present embodiment is not limited thereto.

According to the present embodiment, since the internal electrode protrudes from the surface of the ceramic body, an interdiffusion layer may be formed only on the outside of the ceramic body. That is, according to the present embodiment, it is difficult for the interdiffusion layer to form to the inner side of the ceramic body.

Unlike the present embodiment, if there is no protrusion in the internal electrode, that is, if the internal electrode does not protrude from the ceramic surface, an interdiffusion layer may be formed to the inner side of the ceramic body. In this case, there is a possibility that the interdiffusion layer may expand inside the ceramic body and cause radiating cracks.

In addition, according to the present embodiment, the interdiffusion layer may suppress moisture penetration, thereby preventing deterioration of the multilayer ceramic capacitor.

In addition, according to the present embodiment, the internal electrode includes the protrusion, so that the contact area between the internal electrode and the external electrode is larger compared to the case without the protrusion. Therefore, according to the present embodiment, the internal electrode and the external electrode may be better connected.

While this disclosure has been described in connection with what is presently considered to be practical embodiments, it is to be understood that the disclosure is not limited to the disclosed embodiments, but, on the contrary, is: intended to cover various modifications and equivalent arrangements included within the spirit and scope of the appended claims.

### DESCRIPTION OF SYMBOLS

1000: multilayer ceramic capacitor
110: ceramic body
120: first external electrode
121: first end portion
123: first band portion
125: first edge portion
130: second external electrode
131: second end portion
133: second band portion
135: second edge portion
140: dielectric layer
143: first cover layer
145: second cover layer
150: first internal electrode
151: first protrusion
160: second internal electrode
161: second protrusion
171: first interdiffusion portion
173: second interdiffusion portion
180: first plating layer
190: second plating layer
181, 191: first layer
183, 193: second layer
185, 195: third layer

What is claimed is:

1. A multilayer ceramic capacitor, comprising:
a ceramic body that includes a plurality of dielectric layers and a plurality of internal electrodes stacked in a first direction,
an external electrode disposed outside the ceramic body; and
an interdiffusion portion that includes an alloy or an intermetallic compound (IMC) of a material of the internal electrodes and a material of the external electrode,
wherein one of the internal electrodes includes a protrusion that protrudes from a first surface of the ceramic body and contacts the interdiffusion portion.

2. The multilayer ceramic capacitor of claim 1, wherein
the interdiffusion portion surrounds the protrusion.

3. The multilayer ceramic capacitor of claim 1, wherein
the interdiffusion portion is disposed on the first surface of the ceramic body.

4. The multilayer ceramic capacitor of claim 1, wherein
the material of the one of the internal electrodes includes nickel (Ni), copper (Cu), palladium (Pd), silver (Ag), iron (Fe), or an alloy thereof.

5. The multilayer ceramic capacitor of claim 1, wherein
the material of the external electrode includes nickel (Ni), copper (Cu), palladium (Pd), gold (Au), silver (Ag), cobalt (Co), chromium (Cr), iron (Fe), tin (Sn), platinum (Pt), indium (In), iridium (Ir), rhodium (Rh), tin (Sn), zinc (Zn), or an alloy thereof.

6. The multilayer ceramic capacitor of claim 1, wherein
a length of the interdiffusion portion is greater than a length of the protrusion of the one of the internal electrodes.

7. The multilayer ceramic capacitor of claim 1, wherein
a length of the interdiffusion portion is 0.5 μm or more and 2 μm or less.

8. The multilayer ceramic capacitor of claim 1, further comprising
a plating layer that covers the external electrode.

9. The multilayer ceramic capacitor of claim 8, wherein
the plating layer includes
a first layer that covers the external electrode,
a second layer that covers the first layer, and
a third layer that covers the second layer.

10. The multilayer ceramic capacitor of claim 9, wherein
the first layer includes nickel (Ni),
the second layer includes copper (Cu), and
the third layer includes tin (Sn).

11. The multilayer ceramic capacitor of claim 1, wherein
each of the internal electrodes includes a protrusion that protrudes from the first surface of the ceramic body, and
a plurality of interdiffusion portions that includes an alloy or an intermetallic compound (IMC) of a material of the internal electrodes and a material of the external electrode surround the protrusions of the internal electrodes, respectively.

12. The multilayer ceramic capacitor of claim 11, wherein
the plurality of interdiffusion portions are spaced apart from one another.

13. The multilayer ceramic capacitor of claim 1, wherein
the external electrode comprises an end portion that covers a portion of the first surface of the ceramic body, a band portion that extends from the end portion to cover at least a portion of four surfaces of the ceramic body connected to the first surface, and an edge portion that connects the end portion and the band portion.
